(19) United States
(12) Patent Application Publication
(10) Pub. No.: US 2016/0160542 A1
(43) Pub. Date: Jun. 9, 2016

(54) DOOR PANEL LIMITING METHOD AND PLANAR DOOR STOPPER

(71) Applicant: XMAG CO., LTD. TAIWAN BRANCH (SEYCHELLES), TAIPEI CITY (TW)

(72) Inventor: WEN-CHENG HU, TAIPEI CITY (TW)

(73) Assignees: XMAG CO., LTD. TAIWAN BRANCH (SEYCHELLES), TAIPEI CITY (TW); WEN-CHENG HU, TAIPEI (TW)

(21) Appl. No.: 14/953,686

(22) Filed: Nov. 30, 2015

(30) Foreign Application Priority Data
Dec. 5, 2014 (TW) 103142479

(51) Int. Cl. E05C 17/54; E05C 17/56

(52) U.S. Cl. CPC E05C 17/54; E05C 17/56

(57) ABSTRACT

Disclosed is a planar door stopper installed to a floor with respect to a moving path of a door panel, such that when the door panel is opened, the bottom of the door panel is attracted by the planar door stopper, and the planar door stopper is turned and moved upward and framed around the corners and the periphery of the door panel or extended cross an outer side of the bottom of the door panel, so as to limit the door panel at an opening position and overcome the drawbacks of a conventional door stopper which hinders walkway and causes inconvenient to construction.

### TECHNICAL FIELD

The technical field relates to a door panel limiting method and a planar door stopper, and more particularly to the planar door stopper normally and flatly disposed on a floor and framed around the corners and the periphery of the bottom of a door panel or extended across the thickness of an outer side of the bottom of the door panel.

### BACKGROUND

In general, a conventional door stopper limits the position of a door panel by a magnetic attraction method, and the door stopper is in form of a magnetic lug having a magnet at an end of the door stopper. When use, the door stopper is fixed to a wall behind the door panel, and an iron plate is installed to the backside of the door panel. When the door panel is opened, the iron plate at the backside of the door panel is attracted and attached onto the magnet of the door stopper to maintain the door panel in an open status.

However, the conventional door stopper installed onto a wall has the following problems: Special screws or anchors are required for the installation in order to fix the magnetic lug, and thus causing inconvenience to construction and damaging the wall, and the magnetic lug is an obvious projection on the wall, and thus the magnetic lug may injure a person's leg by collision easily. In addition, the power of limiting the door panel provided for attaching the door panel simply by the magnetic attraction method is insufficient, so that a large-area door panel may be detached from the magnetic lug easily when the wind is relatively large.

Among the advanced conventional door stoppers, the door stoppers are normally and flatly disposed on a floor, and such door stopper has a tab with induced magnetism and swayable upward, and a magnet installed at the bottom of the door panel for magnetically attracting the tab. For instance, Japanese Unexamined Patent Application No. 2001-159265 is one of the typical embodiments of such door stoppers.

However, the door stopper installed to the floor has to make a groove under the door panel and install a magnet into the groove, so that the tab of the door stopper on the floor is movably embedded into the groove. Alternatively, a hardware accessory having a groove is installed under the door panel, and if the groove of the hardware accessory is too narrow, then the tab of the door stopper will not be latched securely. On the other hand, if the groove is too deep, then the thickness of the hardware accessory will be too large, so that the door panel with the bottom too close to the floor cannot be installed. Although the aforementioned two embodiments can reduce the chance of getting injured in a collision, yet they still have the drawbacks of causing inconvenience to construction and damaging the door panel.

In addition, the tab of the aforementioned door panel is obliquely embedded into the groove, and thus just an end of the tab is attracted to the magnet in the groove. The smaller the magnetic attraction area, the less the stopping effect. As a result, the tab of the door stopper may fall off easily in situations such as strong wind or collision to the door panel, and there is an issue of disabling the door stopper easily.

In view of the aforementioned problems, the disclosure of this disclosure based on years of experience in the related industry to conduct extensive researches and experiments, and finally provided a feasible solution to overcome the problems of the prior art.

### SUMMARY

Therefore, it is a primary objective of this disclosure to provide a planar door stopper, particularly a planar door stopper normally and flatly disposed on a floor, magnetically attracted by a surface area, and framed around the corners and the periphery of the bottom of the door panel or extended across the thickness of an outer side of the bottom of the door panel, so as to overcome the aforementioned drawbacks of the prior art, including the inconvenient construction of the conventional door stoppers, and the problems of damaging the door panel, and resulting in a small magnetic attraction area and a poor stopping effect.

To achieve the aforementioned and other objectives, the planar door stopper of this disclosure comprises a fixed plate fixed to a floor; a limiting frame plate pivotally installed on the fixed plate and upwardly swayable with respect to the floor; a first magnetic attraction plate, installed on the limiting frame plate, for driving the limiting frame plate to sway upward with respect to the floor by magnetic attraction; and a limiting slot, formed on the limiting frame plate, and framed around the corners and periphery of the door panel or extended across the thickness of an outer side of the bottom of the door panel when swaying the limiting frame plate upward with respect to the floor.

In an embodiment, the door panel includes a second magnetic attraction plate installed at the bottom of the door panel and capable of producing a magnetic attraction with the first magnetic attraction plate.

In the aforementioned planar door stopper, the fixed plate is flatly fixed to floor, and the limiting frame plate and the first magnetic attraction plate are normally and flatly disposed on floor and stacked on the fixed plate. When the door panel is opened to a position above the limiting frame plate, the second magnetic attraction plate of the door panel and the first magnetic attraction plate of the limiting frame plate produce a magnetic attraction to drive the first magnetic attraction plate to sway the limiting frame plate upwardly, so that the first magnetic attraction plate is magnetically attached onto the second magnetic attraction plate in a planar contact manner, while the limiting slot of the limiting frame plate is swayed upward and framed around the corners and the periphery of the bottom of the door panel or extended across the thickness of an outer side of the bottom of the door panel, so as to achieve the effect of limiting the door panel at an opening position.

To release the limitation of the door panel, a user simply steps on the edge of the limiting frame plate to resume the limiting frame plate and the first magnetic attraction plate to their position of being flatly attached onto the floor, since the limiting slot of the limiting frame plate is framed around the corners and periphery of the bottom of the door panel or extended across the thickness of an outer side of the bottom of the door panel, and the edge of the limiting slot of the limiting frame plate is slightly protruded from the door panel. Therefore, the limitation of the door panel can be released, and the door panel can be rotated and opened freely to provide a very convenience use.

In addition, the fixed plate is fixed to the floor and disposed at a position below the moving door panel while opening the door panel, and the second magnetic attraction plate is fixed to the bottom of the door panel without damaging the wall or door panel during construction, so as to provide a simple and easy construction. In addition, the first magnetic attraction plate and the second magnetic attraction plate may be magnetically attached to each other in a planar contact manner to increase the magnetic attraction area significantly and prevent the first magnetic attraction plate and the second magnetic attraction plate from falling out, and also to prevent the limiting frame plate from falling out from the bottom of the door panel. In the meantime, the limiting slot of the limiting frame plate is provided and framed onto the corners of the bottom of the door panel or extended across the thickness of an outer side of the bottom of the door panel to achieve the effects of stopping the door panel from moving further, and improving the stopping effect of the door stopper.

Embodiments of this disclosure are described below:

According to the aforementioned structural characteristics, the first magnetic attraction plate may be a magnetic plate or a magnetic metal plate, and the second magnetic attraction plate may also be a magnetic plate or a magnetic metal plate. For example, if the first magnetic attraction plate is a magnetic plate, the second magnetic attraction plate may be a magnetic metal plate; or if the first magnetic attraction plate is a magnetic metal plate, the second magnetic attraction plate may be a magnetic plate. Of course, the first magnetic attraction plate and the second magnetic attraction plate may be magnetic plates with opposite magnetic poles.

According to the aforementioned structural characteristics, the limiting slot is substantially in a rectangular shape or U-shape, and the limiting slot has a width greater than the thickness of the door panel.

According to the aforementioned structural characteristics, the first magnetic attraction plate has an inner edge pivoted to an inner periphery of the limiting slot, and the fixed plate has a link plate pivoted to the fixed plate and capable of swaying upward with respect to the floor, and the first magnetic attraction plate has an end pivoted to the limiting frame plate and the other end pivoted to the link plate, so that the linkage of the mutually pivoted fixed plate, link plate, first magnetic attraction plate, limiting frame plate defines a four-link-rod assembly. Therefore, if the first magnetic attraction plate is magnetically attracted by the second magnetic attraction plate, the first magnetic attraction plate will be moved upwardly in a horizontal moving manner while driving the limiting frame plate and the link plate to move upward, so that the first magnetic attraction plate is still parallel to the floor and the bottom of the door panel during the whole moving process, so that the first magnetic attraction plate is parallel to the bottom of the door panel and upwardly attached onto a surface of the second magnetic attraction plate to provide a stable magnetic attraction effect.

This disclosure further provides a door panel limiting method comprising the steps of: installing a planar door stopper to a floor and the planar door stopper being configured to be corresponsive to a moving path of a door panel, and the planar door stopper including a first magnetic attraction plate and a limiting frame plate linked to the first magnetic attraction plate, and an end of the limiting frame plate being pivoted to the planar door stopper and swayable upward, and the other end of the limiting frame plate having a limiting slot with a width greater than the thickness of the door panel; and installing a second magnetic attraction plate at the bottom of the door panel and the second magnetic attraction plate being configured to be corresponsive to the first magnetic attraction plate, such that when the door panel is opened, the attraction of the second magnetic attraction plate exerted to the first magnetic attraction plate drives the first magnetic attraction plate and the limiting frame plate to turn and move upward, and the limiting slot of the limiting frame plate is framed around the corners and the periphery of the door panel or extended cross an outer side of the bottom of the door panel, so as to limit the door panel at an opening position.

In the aforementioned method, the first magnetic attraction plate has an inner end pivoted to an inner edge of the limiting slot, and the planar door stopper has a fixed plate disposed at the bottom of the planner door stopper and flatly fixed onto the floor, and an end of the limiting frame plate is pivoted to an outer end of the fixed plate, and an inner end of the fixed plate is further pivoted to a link plate, and the other end of the link plate away from the fixed plate is pivoted to an outer end of the first magnetic attraction plate, so that a four link rod structure is formed among the mutually pivoted fixed plate, link plate, first magnetic attraction plate, and limiting frame plate, and when the first magnetic attraction plate is magnetically attracted by the second magnetic attraction plate, the first magnetic attraction plate is capable of moving parallel to the floor and displacing upward with respect to the bottom of the door panel, while driving the limiting frame plate and the link plate to sway upward, and the first magnetic attraction plate is capable of being magnetically attached onto a surface of the second magnetic attraction plate in a planar contact manner.

### BRIEF DESCRIPTION OF THE DRAWINGS

FIG. 1 is a perspective view of a first preferred embodiment of this disclosure;

FIG. 2 is a schematic perspective view showing a using status of the first preferred embodiment of this disclosure as depicted in FIG. 1;

FIG. 3 is an exploded view of the first preferred embodiment of this disclosure as depicted in FIG. 1;

FIG. 4 is a sectional view of the first preferred embodiment of this disclosure as depicted in FIG. 1;

FIG. 5 is a sectional view of the first preferred embodiment of this disclosure as depicted in FIG. 2;

FIG. 6 is a schematic perspective view showing a using status of the first preferred embodiment of this disclosure as depicted in FIG. 2;

FIG. 7 is a sectional view of the first preferred embodiment of this disclosure as depicted in FIG. 6;

FIG. 8 is a schematic perspective view showing a using status of a second preferred embodiment of this disclosure; and

FIG. 9 is a schematic side view showing a using status of the second preferred embodiment of this disclosure.

### DESCRIPTION OF THE PREFERRED EMBODIMENTS

The technical content of this disclosure will become apparent with the detailed description of preferred embodiments and the illustration of related drawings as follows.

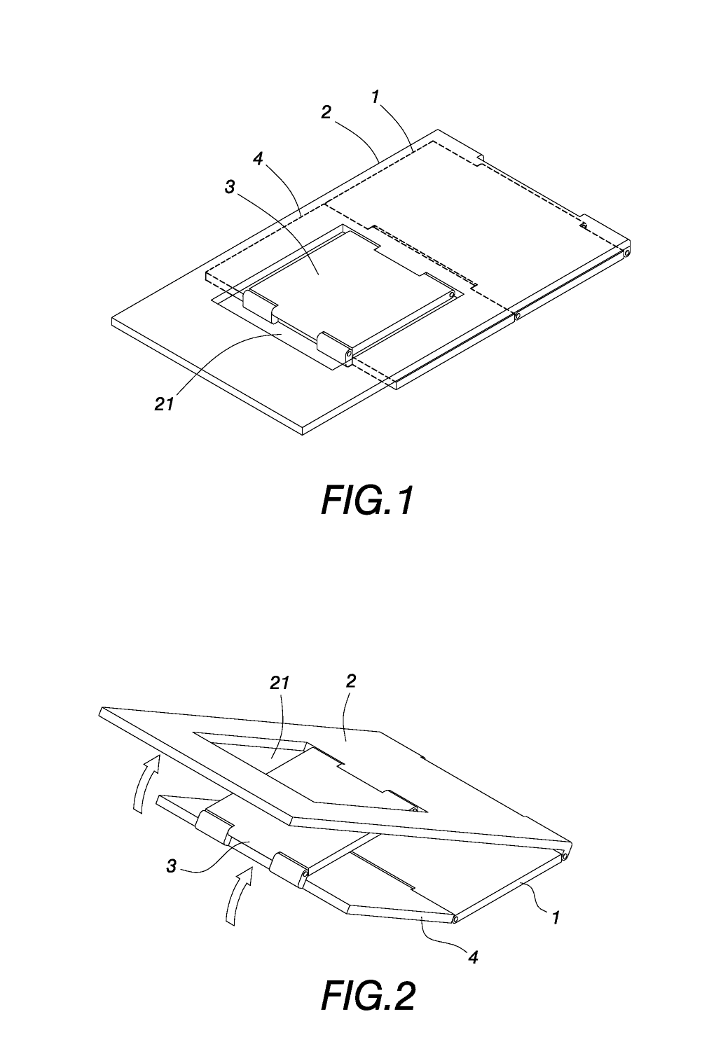

With reference to FIGS. 1 to 5 for a planar door stopper in accordance with a preferred embodiment of this disclosure, the planar door stopper comprises a fixed plate 1, a limiting frame plate 2 and a first magnetic attraction plate 3. The fixed plate 1 may be fixed to the floor by adhesion or a locking method, and an end of the limiting frame plate 2 is pivoted to the fixed plate 1 through a first shaft 51, so that the limiting frame plate 2 can be swayed upwardly with respect to the floor.

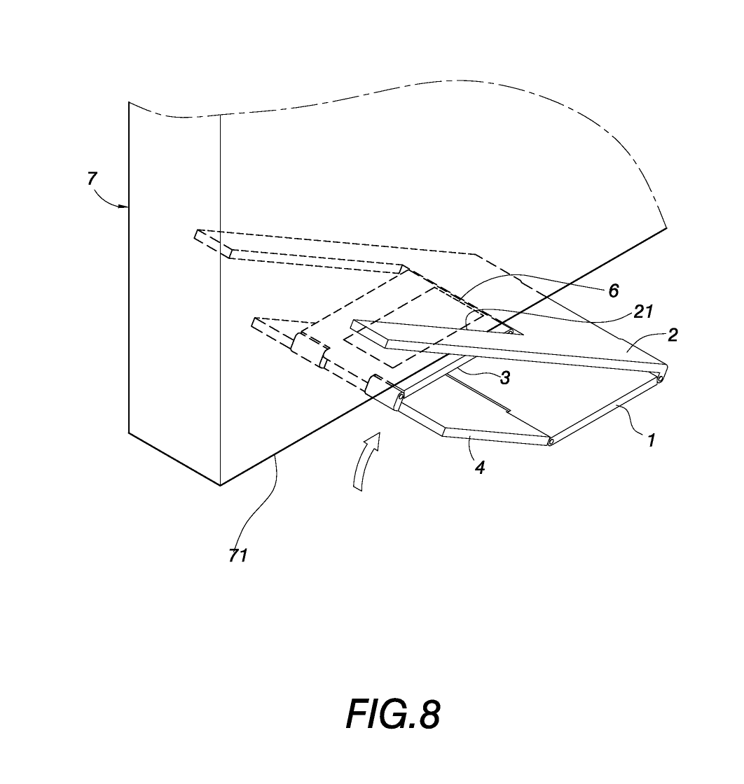

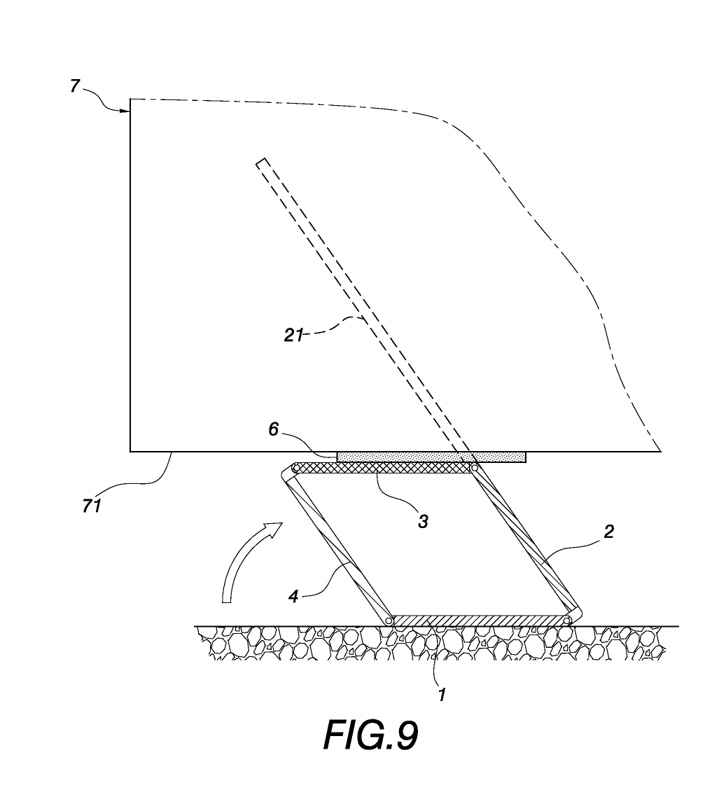

The limiting frame plate 2 has a limiting slot 21 with a width greater than the thickness of the door panel, and the first magnetic attraction plate 3 is installed onto the limiting frame plate 2 and an inner side of the magnetic attraction plate 3 is pivoted to the inner edge of the limiting slot 21, so that the first magnetic attraction plate 3 can sway the limiting frame plate 2 to move upwardly with respect to the floor by magnetic attraction, and the limiting slot 21 is swayed together with the limiting frame plate 2 to move upwardly with respect to the floor. In FIGS. 1 to 7, the limiting slot 21 is substantially in a rectangular shape, so that the limiting slot 21 has an effect of limiting the door panel by the corners 71 of the bottom of the door panel 7. In another embodiment, the limiting slot 21 may be U-shaped as shown in FIGS. 8 and 9 and extended across the outside thickness of the door panel 7 to limit the bottom of the door panel 7.

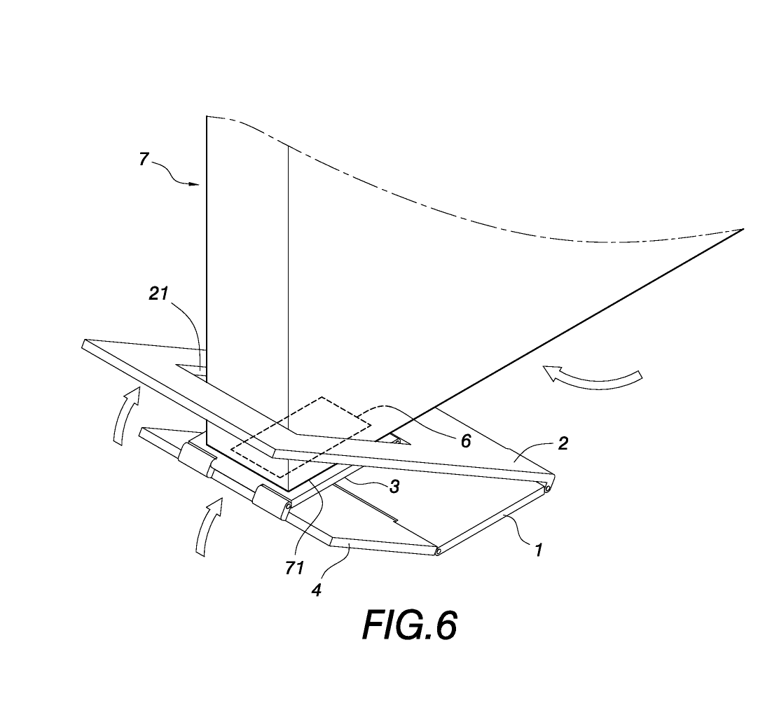

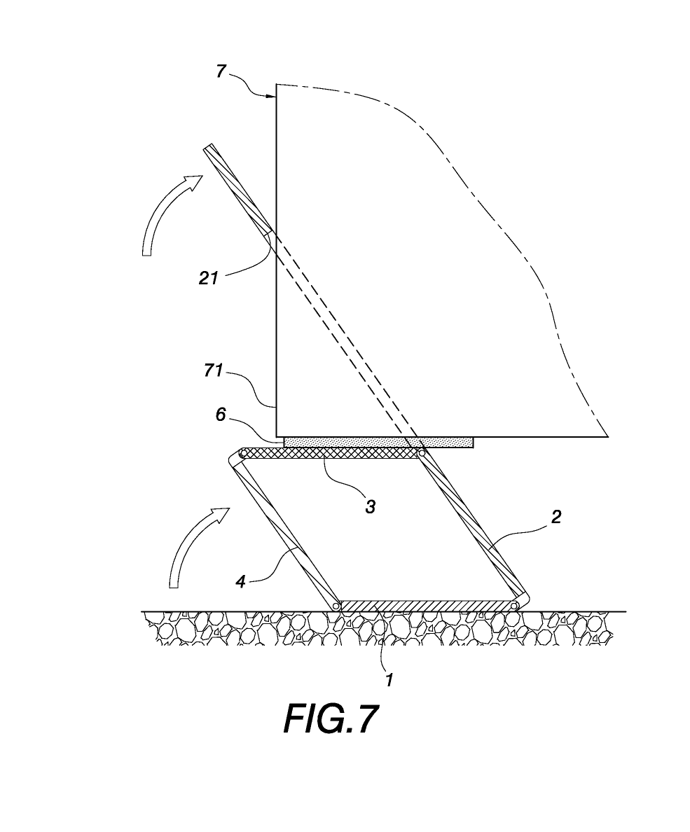

In FIGS. 6 and 7, the corner 71 of the door panel 7 further includes a second magnetic attraction plate 6 capable of producing magnetic attraction with the first magnetic attraction plate 3. In FIGS. 8 and 9, the second magnetic attraction plate 6 is not necessary to be installed at the corner 71 of the bottom of the door panel 7. As long as the bottom of the door panel 7 is configured to be corresponsive to the first magnetic attraction plate 3 and capable of attracting the first magnetic attraction plate 3 to move upward.

In the embodiment, the first magnetic attraction plate 3 is a magnetic plate or a magnetic metal plate, and the second magnetic attraction plate 6 is also a magnetic plate or a magnetic metal plate. Specifically, if the first magnetic attraction plate 3 is a magnetic plate, the second magnetic attraction plate 6 may be a magnetic metal plate. Alternatively, if the first magnetic attraction plate 3 is a magnetic metal plate, the second magnetic attraction plate 6 may be a magnetic plate, or both of the first magnetic attraction plate 3 and the second magnetic attraction plate 6 are magnetic plates with opposite magnetic poles.

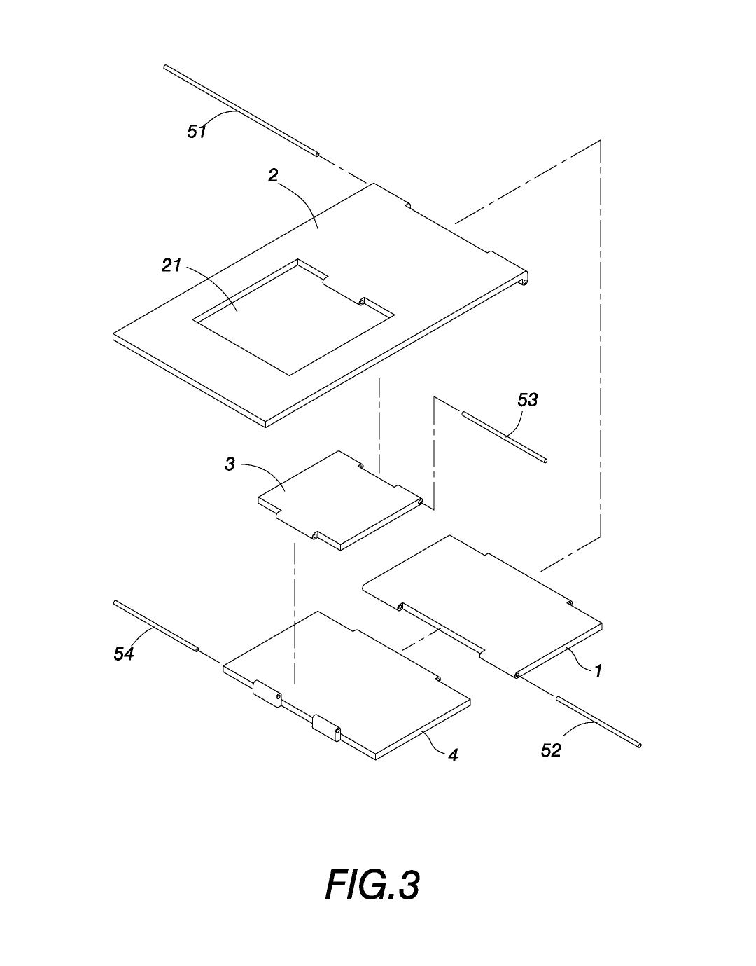

In FIG. 3, the fixed plate 1 is pivoted to a link plate 4 through a second shaft 52, and the limiting frame plate 2 and the link plate 4 are pivoted to both ends of the fixed plate 1 respectively, so that the link plate 4 can be swayed upwardly with respect to the floor. The first magnetic attraction plate 3 has an end pivoted to an inner edge of the limiting slot 21 by a third shaft 53 and the other end pivoted to the link plate 4 by a fourth shaft 54, and both ends of the first magnetic attraction plate 3 are pivoted to the limiting frame plate 2 and the link plate 4 respectively. With the pivoting relationship between the aforementioned components, the linkage among the fixed plate 1, the limiting frame plate 2, the first magnetic attraction plate 3 and the link plate 4 defines a four-link-rod assembly.

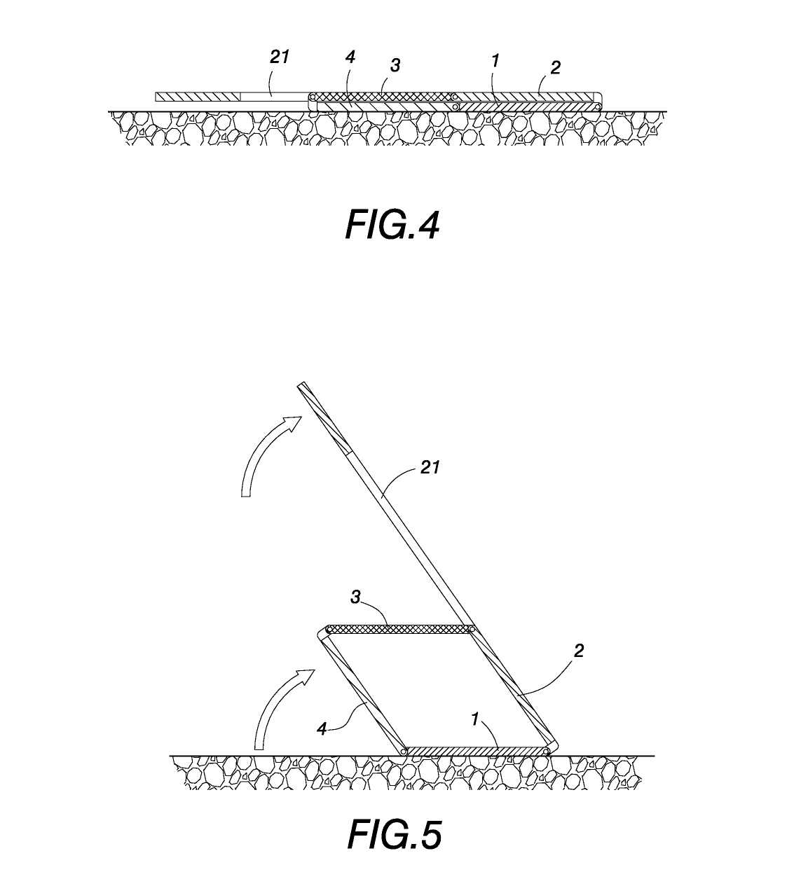

In FIGS. 4 and 5, the fixed plate 1 is flatly fixed to the floor during use, and the link plate 4 together with the fixed plate 1 may be fixed to the floor, and the limiting frame plate 2 and the first magnetic attraction plate 3 are normally and flatly disposed on the floor and stacked on the fixed plate 1 and the link plate 4.

In FIGS. 6 and 7, when the door panel 7 is opened to a position above the limiting frame plate 2, the second magnetic attraction plate 6 of the door panel 7 and the first magnetic attraction plate 3 of the limiting frame plate 2 produce magnetic attraction to drive the first magnetic attraction plate 3 to move the limiting frame plate 2 and the link plate 4 synchronously upward.

Now, the four-link-rod linkage of the aforementioned components is capable of maintaining the first magnetic attraction plate 3 to be parallel to the floor and the bottom of the door panel 7 in the whole moving process, so that the first magnetic attraction plate 3 is attached to the surface of the second magnetic attraction plate 6 in the manner of being parallel to the bottom of the door panel 7, so as to provide stable magnetic attraction and magnetically attract the first magnetic attraction plate 3 to the second magnetic attraction plate 6. In the meantime, the limiting slot 21 of the limiting frame plate 2 is swayed upwardly, so that the limiting slot 21 as shown in FIGS. 6 and 7 are framed at the corners 71 at the bottom of the door panel 7 or the outer periphery of the door panel 7. Alternatively, the limiting slot 21 is extended across an outer side of the thickness of the bottom of the door panel 7 as shown in FIGS. 8 and 9, so that even if there is a strong wind or a person colliding with the door panel 7, the limiting slot 21 framed at the corners 71 or the periphery of the bottom of the door panel 7 will not fall out easily, so as to provide the effect of stopping the door panel 7 stably.

To release the limitation of the limiting frame plate 2 on the door panel 7, a user simply steps on the edge of the limiting frame plate 2 to resume the limiting frame plate 2 and the first magnetic attraction plate 3 to their position of being flatly attached onto the floor, since the limiting slot 21 of the limiting frame plate 2 is framed around the corners 71 and the periphery of the bottom of the door panel or extended across the thickness of an outer side of the bottom of the door panel 7, and the edge of the limiting slot 21 of the limiting frame plate 2 is slightly protruded from the door panel 7. Therefore, the limitation of the door panel 7 can be released, and the door panel 7 can be rotated and opened freely to provide a very convenience use.

In addition, the fixed plate 1 is fixed to the floor and at a position along the moving path of the door panel 7 during construction, and the second magnetic attraction plate 6 is fixed to the bottom of the door panel 7 without damaging the wall or the door panel 7, so as to provide a simple, convenient and quick construction. In addition, the first magnetic attraction plate 3 and the second magnetic attraction plate 6 are magnetically attracted to each other in a planar contact manner, and thus achieving the effects of increasing the magnetic attraction area significantly, and preventing the first magnetic attraction plate 3 and the second magnetic attraction plate 6 from falling out, so as to prevent the limiting frame plate 2 from falling out from the periphery of the corners 71 of the bottom of the door panel 7. In the meantime, the limiting slot 21 of the limiting frame plate 2 is framed around the corners 71 of the bottom of the door panel 7 or the outer thickness of the bottom of the door panel 7 to stop the door panel 7 from moving, so as to achieve a stable limiting effect and improve the stopping effect of the door stopper.

According to the aforementioned embodiment, this disclosure further provides a door panel limiting method comprising the steps of: installing a planar door stopper to a floor and the planar door stopper being configured to be corresponsive to a moving path of a door panel 7, and the planar door stopper including a first magnetic attraction plate 3 and a limiting frame plate 2 linked to the first magnetic attraction plate 3, and an end of the limiting frame plate 2 being pivoted to the planar door stopper and swayable upward, and the other end of the limiting frame plate 2 having a limiting slot 21 with a width greater than the thickness of the door panel 7; and installing a second magnetic attraction plate 6 at the bottom of the door panel 7 and the second magnetic attraction plate 6 being configured to be corresponsive to the first magnetic attraction plate 3, such that when the door panel 7 is opened, the attraction of the second magnetic attraction plate 6 exerted to the first magnetic attraction plate 3 drives the first magnetic attraction plate 3 and the limiting frame plate 2 to turn and move upward, and the limiting slot 21 of the limiting frame plate 2 is framed around the corners 71 and the periphery of the door panel 7 or extended cross an outer side of the bottom of the door panel 7, so as to limit the door panel 7 at an opening position.

In the aforementioned method, this embodiment is the same as the previous one. In addition to the limiting frame plate 2 having the limiting slot 21 and the first magnetic attraction plate 3, this embodiment further comprises a fixed plate 1 and a link plate 4, and the linkage among the mutually pivoted fixed plate 1, limiting frame plate 2, first magnetic attraction plate 3 and link plate 4 forms a four-link-rod assembly. When the first magnetic attraction plate 3 is magnetically attracted by the second magnetic attraction plate 6, the limiting frame plate 2 and the link plate 4 are driven to sway upward simultaneously, so that the first magnetic attraction plate 3 is still parallel to the floor and the bottom of the door panel 7 during the moving process, and the first magnetic attraction plate 3 is parallel to the bottom of the door panel 7 and upwardly attached onto a surface of the second magnetic attraction plate 6, and the two magnetic attraction plates are magnetically attached with each other in a planar contact manner, so as to increasing the magnetic attraction area and preventing the first magnetic attraction plate 3 and the second magnetic attraction plate 6 from falling out.

What is claimed is:

1. A planar door stopper, comprising:
a fixed plate fixed to a floor;
a limiting frame plate pivotally installed on the fixed plate and upwardly swayable with respect to the floor;
a first magnetic attraction plate, installed on the limiting frame plate, for driving the limiting frame plate to sway upward with respect to the floor by magnetic attraction; and
a limiting slot, formed on the limiting frame plate, and framed around the corners and periphery of the door panel or extended across the thickness of an outer side of the bottom of the door panel when swaying the limiting frame plate upward with respect to the floor.

2. The planar door stopper according to claim 1, wherein the door panel includes a second magnetic attraction plate installed at the bottom of the door panel and capable of producing a magnetic attraction with the first magnetic attraction plate.

3. The planar door stopper according to claim 2, wherein the first magnetic attraction plate is a magnetic plate or a magnetic metal plate.

4. The planar door stopper according to claim 3, wherein the second magnetic attraction plate is magnetic plate or a magnetic metal plate corresponsive to the first magnetic attraction plate.

5. The planar door stopper according to claim 1, wherein the limiting slot is substantially in a rectangular shape or U-shape, and the limiting slot has a width greater than the thickness of the door panel.

6. The planar door stopper according to claim 5, wherein the first magnetic attraction plate has an inner edge pivoted to an inner periphery of the limiting slot.

7. The planar door stopper according to claim 6, wherein the fixed plate has a link plate pivoted to the fixed plate and capable of swaying upward with respect to the floor, and an outer edge of the first magnetic attraction plate is pivoted to the link plate.

8. A door panel limiting method, comprising the steps of installing a planar door stopper to a floor and the planar door stopper being configured to be corresponsive to a moving path of a door panel, and the planar door stopper including a first magnetic attraction plate and a limiting frame plate linked to the first magnetic attraction plate, and an end of the limiting frame plate being pivoted to the planar door stopper and swayable upward, and the other end of the limiting frame plate having a limiting slot with a width greater than the thickness of the door panel; and installing a second magnetic attraction plate at the bottom of the door panel and the second magnetic attraction plate being configured to be corresponsive to the first magnetic attraction plate, such that when the door panel is opened, the attraction of the second magnetic attraction plate exerted to the first magnetic attraction plate drives the first magnetic attraction plate and the limiting frame plate to turn and move upward, and the limiting slot of the limiting frame plate is framed around the corners and the periphery of the door panel or extended cross an outer side of the bottom of the door panel, so as to limit the door panel at an opening position.

9. The door panel limiting method according to claim 8, wherein the first magnetic attraction plate has an inner end pivoted to an inner edge of the limiting slot, and the planar door stopper has a fixed plate disposed at the bottom of the planner door stopper and flatly fixed onto the floor, and an end of the limiting frame plate is pivoted to an outer end of the fixed plate, and an inner end of the fixed plate is further pivoted to a link plate, and the other end of the link plate away from the fixed plate is pivoted to an outer end of the first magnetic attraction plate, so that a four link rod assembly is formed among the mutually pivoted fixed plate, link plate, first magnetic attraction plate, and limiting frame plate, and when the first magnetic attraction plate is magnetically attracted by the second magnetic attraction plate, the first magnetic attraction plate is capable of moving parallel to the floor and displacing upward with respect to the bottom of the door panel, while driving the limiting frame plate and the link plate to sway upward, and the first magnetic attraction plate is capable of being magnetically attached onto a surface of the second magnetic attraction plate in a planar contact manner.
